(19) United States
(12) Patent Application Publication
(10) Pub. No.: US 2005/0161916 A1
(43) Pub. Date: Jul. 28, 2005

(54) All terrain cart with suspension

(76) Inventor: Michael Blake Taylor, Fairview, NC (US)

Correspondence Address: Michael Blake Taylor, 1615 Charlotte Highway, Fairview, NC, 28730, US

(21) Appl. No.: 10/766,795

(22) Filed: Jan. 27, 2004

(51) Int. Cl. B62B 1/00

(52) U.S. Cl. 280/655.1

(57) ABSTRACT

An improved cart for use in transporting various materials over all types of terrain. The cart has a frame 10 thru 19, a cargo platform 60 thru 66 which is perpendicular to the frame to transport cargo and rotates to the frame for compact storage, and a handle 20 which retracts into the frame. A combination of a suspension system 40 thru 45, wide wheel base 50, and pneumatic tires 30 allows for widely diverse cargo to be transported over most types of indoor and outdoor terrain. The suspension system is fixed at forty five degrees to the frame providing the most efficient suspension system operation.

### BACKGROUND OF THE INVENTION—FIELD OF INVENTION

This invention relates to two wheeled hand carts, specifically to a cart with a suspension system.

### BACKGROUND OF THE INVENTION

Carts and hand trucks are designed and used for specific purposes. Luggage carts move luggage over smooth, indoor surfaces. Hand trucks move heavy, bulky material from delivery vehicles into businesses. Utility carts move such things as yard waste over turf. A need yet to be addressed is a cart with the versatility to carry loads over all types of terrain, such as painting supplies across fields enabling artists to paint on location.

Luggage carts normally have solid tires, are lightweight and are foldable. They are designed to be easily transportable and are for use on smooth, flat surfaces only. For example, U.S. Pat. No. 4,458,914 to Holtz on Jul. 10, 1984 is typical of luggage carts. The cart folds and collapses to a very compact storage condition, incorporates a luggage supporting platform, collapsible handle, and small, solid wheels. Like all such carts, it is designed for flat, smooth surfaces only.

Hand trucks are used to move larger, heavier or bulkier loads. They are therefore larger and heavier than luggage carts. Hand trucks normally have pneumatic tires and a heavy duty, rigid frame. This allows for heavier loads to be moved over relatively flat surfaces and to maneuver over curbs. An example of a typical hand truck is U.S. Pat. No. 4,563,014 to Mortenson on Jan. 7, 1986. This hand truck incorporates a large, rigid frame, wheel base the same width as the frame, and relatively large wheels rigidly secured to the frame. Such hand trucks are useful to move merchandise from delivery vehicles into businesses over paved parking lots and curbs. Hand trucks are heavy and not readily transportable in private vehicles or in cramped spaces.

Several types of utility carts for use on turf and sand have been developed. They normally have wide, solid tires and an enclosure or platform for bulky, lightweight cargo such as yard waste, or beach paraphernalia. These carts tend to be designed for a specific purpose such as U.S. Pat. No. 4,887,837 to Bonewicz on Dec. 19, 1989. This cart is designed specifically to move beach paraphernalia over beach sand. This is facilitated by the use of wide, solid wheels rigidly attached to the cart frame that resist sinking into the sand. Utility carts are not designed for indoor use or to move heavy loads over rough terrain.

Carts and hand trucks are designed for specific purposes. Some to move luggage over smooth, indoor surfaces. Some to move heavy cartons from parking lots into businesses. Some are used on lawns to move leaves and clippings or to move beach towels over beach sand. A need yet to be addressed is an all terrain cart to move light to moderate loads over both indoor and outdoor terrain including carpet, gravel, tile, grass, slopes, and bumpy, uneven terrain. To accomplish this, the cart requires a suspension system.

Suspension systems have been developed to address a number of requirements. For example, U.S. Pat. No. 6,149,169 to Chelgren on Nov. 21, 2000 provides shock absorption for caster wheels. U.S. Pat. No. 6,260,871 to Liu on Jul. 17, 2001 provides for reducing the shock associated with traveling over bumps and dents by the use of swing arms. The system does not utilize a suspension with shock absorbers.

All of the existing devices heretofore known suffer from a number of disadvantages.
a. The primary disadvantage is the lack of a suspension system to enable usage over rough and uneven terrain. The existing devices are not suitable for use on gravel, bumpy ground, slopes, and rocky terrain.
b. Lightweight carts, such as luggage carts, will only operate on very level, smooth surfaces. They will not roll over even small pebbles due to their small, hard rubber, or plastic tires.
c. Hand carts, due to their pneumatic tires, can be pulled over obstructions. But the lack of a suspension system makes the truck bounce and become unstable when moved over rough or sloping terrain.
d. Utility carts with large, solid tires move easily over smooth lawns or sand. They are not suitable for surfaces such as rough gravel or bumpy terrain. These carts can carry bulky cargo like leaves but are unsuitable for even moderately heavy items.
e. The wheel base of known devices is kept narrow to facilitate use indoors and for a more compact profile when being transported. This creates an unstable platform prone to tipping over when traversing rough terrain or crossing slopes.
f. Hand trucks are large and heavy with rigid frames that do not fold up. They are therefore difficult to transport in the back seat or trunk of a car.

### BACKGROUND OF INVENTION-OBJECTS AND ADVANTAGES

Accordingly, several objects and advantages of my cart are:
a. to provide a cart capable of easily and effectively traversing all types of terrain. The cart will be versatile enough for use on indoor surfaces, pavement, grass, gravel, sandy soil, bumpy terrain, and slopes.
b. to provide a cart with a suspension system to absorb the shocks of bumpy or uneven terrain. This will allow for smooth, stable, and controllable transport of goods over rough terrain.
c. to provide a cart which folds for compact storage and transport.
d. to provide a cart which keeps its cargo above wet grass whether stationary or during movement.
e. to provide a cart with a folding cargo platform for easier transport.
f. to provide a cart with a folding cargo platform support. The support folds out of the way during transport for a more compact profile.
g. to provide a cart with a retractable handle for easy transport.
h. to provide a cart that can transport small, compact loads as well as larger, bulkier loads.
i. to provide a cart with the versatility to be easily transported capable of carrying different types of cargo and with the ability to effectively traverse all manner of terrain.

Further objects and advantages are to provide a cart with maximum versatility and ease of use. It incorporates the portability and compact nature of the luggage cart and the pneumatic tires of the hand truck. The addition of a suspension system and a wide wheel base provide a cart capable of great versatility. Still further objects and advantages will become apparent from a consideration of the ensuing description and drawings.

### SUMMARY

The present invention is an all purpose cart that folds for easy transport. The cart incorporates a suspension system, pneumatic tires, and wide wheel base to enhance performance on all types of terrain.

### DRAWINGS

FIG. 1 is a perspective view of my invention in the stationary position.

FIG. 2 is an exploded view of the handle portion of my invention.

FIG. 3 is a broken view of the handle and associated frame section of my invention.

FIG. 4 is a simplified side view of my invention.

FIG. 5 is a simplified side view of an alternate embodiment of my invention with the system parallel to the frame.

FIG. 6 is a perspective view of the suspension, wheel, and axle sections of my

FIG. 7 is an exploded view of the suspension, wheel, and axle sections of my invention.

DRAWINGS--Reference Numerals

| | | | |
|---|---|---|---|
| 10 | inside vertical frame | 11 | upper cross support |
| 12 | lower cross support | 14 | outside vertical frame |
| 16 | wheel support | 18 | wheel brace |
| 19 | middle cross support | 20 | handle |
| 22 | knob | 24 | threaded hole |
| 26 | upper handle stop | 28 | lower handle stop |
| 30 | wheel | 32 | wheel lock nut |
| 40 | suspension guide | 41 | spring piston |
| 42 | suspension lock nut | 43 | suspension spring |
| 44 | upper spring retainer | 45 | lower spring retainer |
| 50 | axle guide | 52 | axle |
| 60 | platform outer ring | 62 | platform inner member |
| 64 | platform leg | 66 | platform cross support |

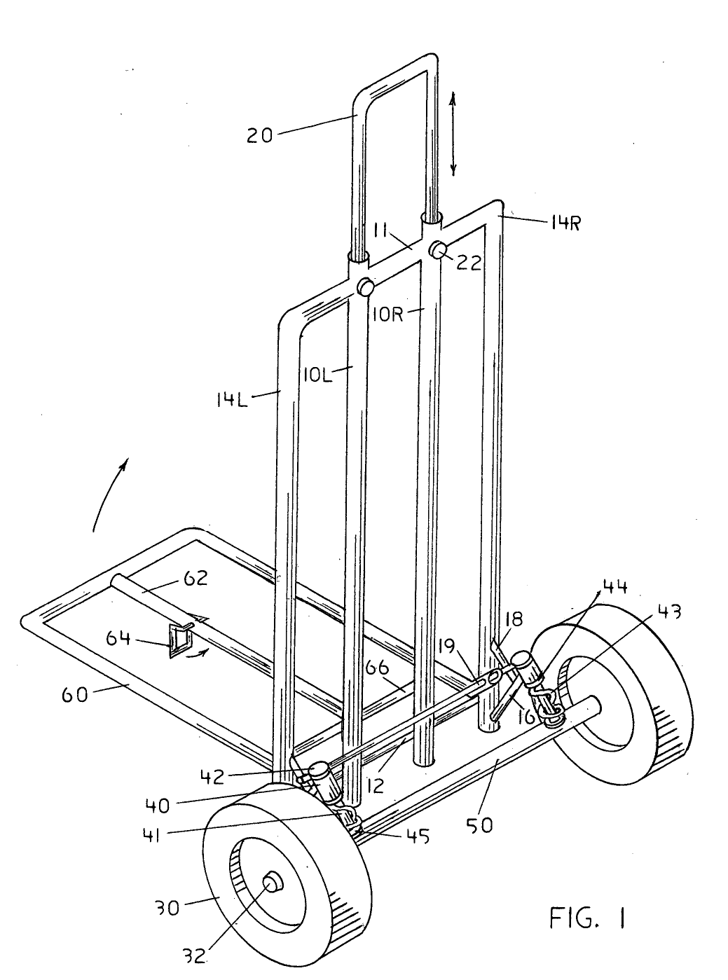

### DETAILED DESCRIPTION—FIGS. 1, 2, 3, 4, 6, and 7—PREFERRED EMBODIMENT

FIG. 1 shows a perspective view of the preferred embodiment of my cart. A central frame comprises two inside vertical members of uniform tubular material 10R and 10L that are connected by upper cross support 11 of the same tubular material, lower cross support 12 of solid bar stock, and middle cross support 19, of the same solid bar stock. Two outside vertical members 14R and 14L, of the same tubular material, also connect to support 12 and curve ninety degrees to join members 10R and 10L, just below the top of the members.

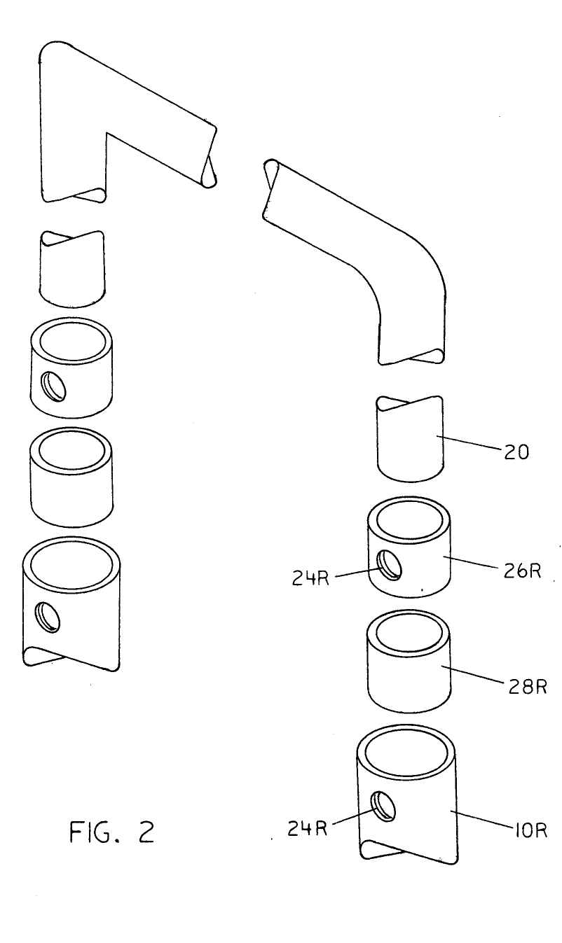

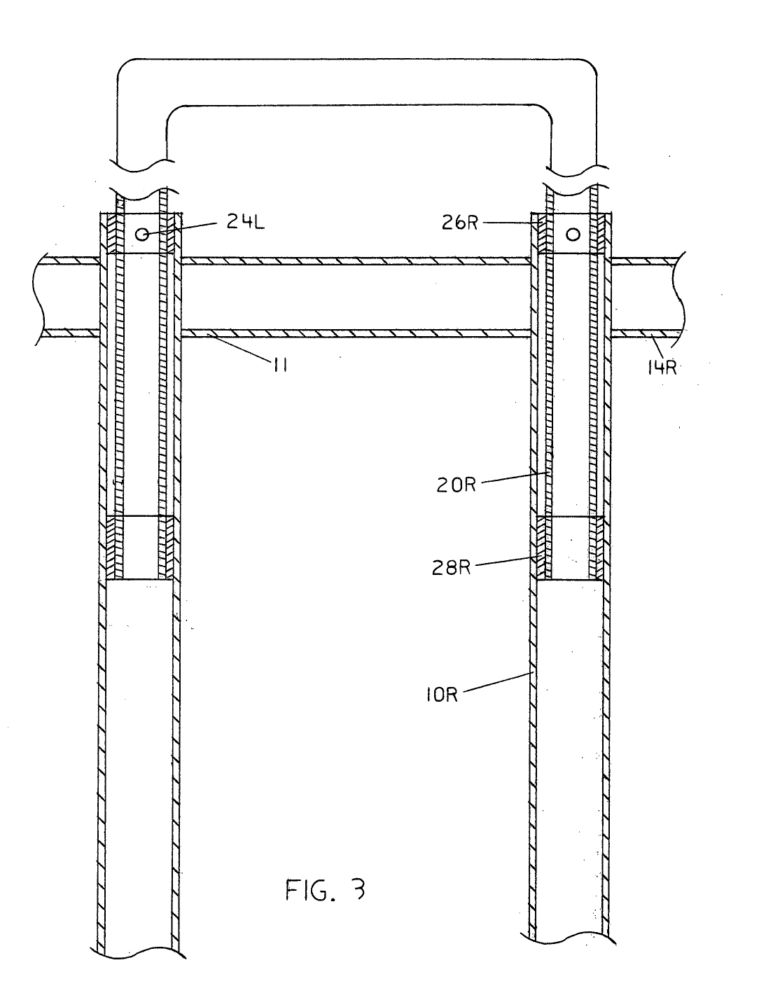

FIG. 2 is an exploded perspective view and FIG. 3 is a broken view of the handle and associated frame section of the cart. As shown in FIG. 1, FIG. 2, and FIG. 3, two upper handle stops 26R and 26L, of tubular material sized for a friction fit into members 10R and 10L, are secured at the top ends of the members. A handle 20, of uniform tubular material sized to pass through the stops 26R and 26L, without excessive friction or play, inserts through the stops and into members 10R and 10L. Knobs 22R and 22L screw through tapped holes 24R and 24L to contact handle 20. Two lower handle stops 28R and 28L, of the same tubular material and size as stops 26R and 26L, are affixed to both ends of handle 20.

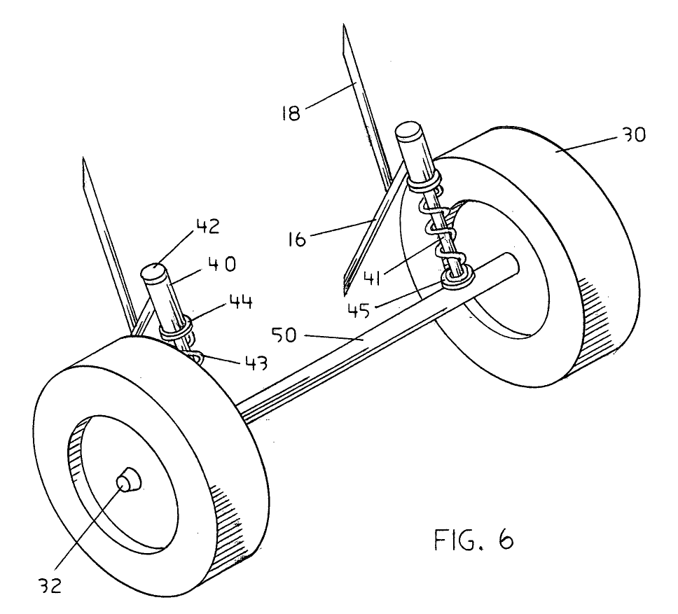

FIG. 6 is a perspective view of the suspension, wheel, and axle sections of the cart. As shown in FIG. 1 and FIG. 6, two wheel supports 16R and 16L, of uniform tubular material, connect to members 14R and 14L. Two suspension guides 40R and 40L, of uniform tubular material, are connected at right angles to the wheel supports 16R and 16L. Two wheel braces 18R and 18L, of the same material as the wheel supports 16R and 16L, connect to the wheel supports 16R and 16L and the frame members 14R and 14L.

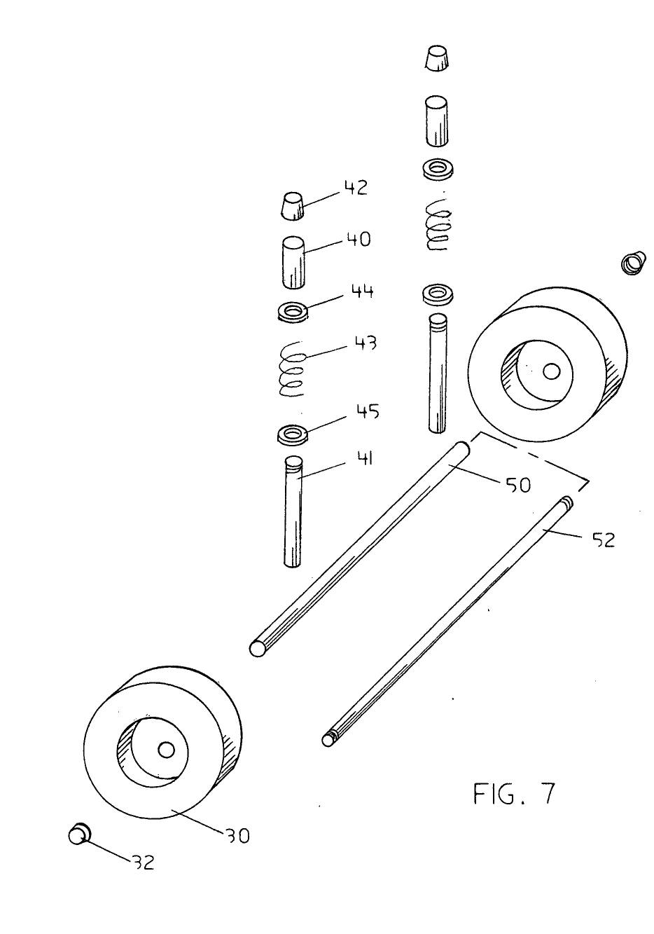

FIG. 7 is an exploded view of the suspension, wheel, and axle sections of the cart. As shown in FIG. 6 and FIG. 7, two spring pistons 41R and 41L, of uniform solid bar stock, ride back and forth through suspension guides 40R and 40L and are prevented from passing through them by two suspension lock nuts 42R and 42L. Spring pistons 41R and 41L also pass through the two suspension springs 43R and 43L held in place by two upper spring retainers, or washers, 44R and 44L and two lower spring retainers, or washers, 44R and 45L.

Spring pistons 41R and 41L are attached to the axle guide 50, of uniform tubular material, at right angles. An axle 52, of solid bar stock, passes through the axle guide 50. Two wheels 30R and 30L slip onto both ends of the axle and are secured in place by two wheel lock nuts 32R and 32L The two suspension guides 40R and 40L are connected by a single middle cross support 19, of solid bar stock.

As shown in FIG. 1, support 12 passes through both ends of the platform outer ring 60, of uniform tubular material, securing it to the frame assembly and allowing the platform to rotate from the cargo to the storage position. The platform inner member 62 connects to ring 60 in its center and is of the same material. The platform cross support 66, of the same material, also connects to ring 60. A platform leg 64, of solid bar stock, passes through member 62 and pivots around same.

Operation—FIGS. 1, 2, 3, 4, 5, 6 and 7.

The cart is used to move materials. Handle 20 is used to pull the cart when moving cargo. It retracts into and pulls out of two sections of the inner vertical frame 10 as shown in FIG. 1, FIG. 2, and FIG. 3. The handle is stopped from coming completely out of the frame when contact is made between upper handle stops 26, secured at the uppermost section of inside vertical frame members 10, and lower handle stops 28, secured to the bottom of handle 20. Handle 20 can be held in a partially extended position by two knobs 22, which screw through the threaded holes 24 and contact handle 20. If knobs 22 are not in contact with handle 20, handle 20 is free to completely extend until lower hand stops 28 and upper handle stops 26 come into contact. When released, gravity will cause handle 20 to retract inside vertical frame 10. Lower handle stops 26 also serve to guide handle 20 through the frame preventing binding and wobble.

Platform 60 rotates from a lowered position for moving cargo to a raised position for storage or transport without cargo. Platform 60 is held in place in the lowered position by gravity and the weight of the cargo and is supported from the bottom when in the lowered position by platform leg 64 which folds out of the way for storage by the force of gravity. Cargo is placed on platform 60 for transport and is secured in place for transport by bungi cords or straps passing around the cargo and the frame.

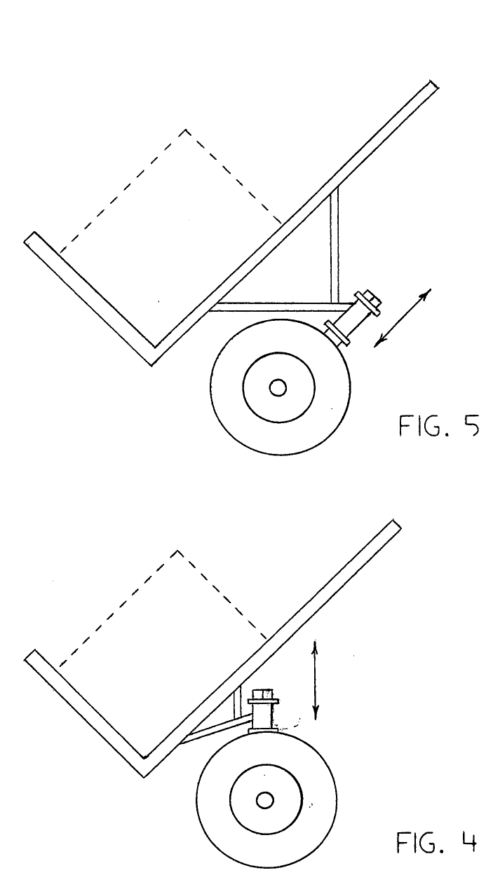

In order to transport cargo, handle 20 is grasped by either hand of the individual using the cart. As the cart is pulled forward into the cargo moving position, the frame tilts until it is at an angle of approximately forty five degrees relative to the ground. As shown in FIG. 4, this places suspension spring 43 at a right angle to the ground, the most optimum orientation for effective operation of the suspension.

As the cart passes over rough or uneven terrain, the load placed on suspension springs 43 increases. Such increasing loads are absorbed by the suspension springs and pneumatic tires 30. Suspension spring 43 will compress and decompress as the load on the spring is increased, absorbed, and dissipated by the spring. This is done most efficiently when suspension spring 43 is at a right angle to the ground. This requires the suspension to be at a forty five degree angle relative to the frame. The result is smooth travel over all types of terrain including grass, gravel, bumpy terrain, and slopes.

FIG. 5—Alternative Embodiments

There are various possibilities with regard to the suspension system. The spring suspension system can be parallel to the frame. This will provide some degree of shock absorption, but will not be as effective as when the suspension is perpendicular to the ground as shown in FIG. 4. As shown in FIG. 5, if the suspension spring were parallel to the frame, it would not be as effective in absorbing the shocks and bumps of uneven terrain as it would be at a forty five degree angle relative to the ground when in operation.

An air shock suspension can be used in place of the spring suspension. This will provide excellent operation but will be more expensive to manufacture than the spring suspension system.

Another type of elastometric member, such as rubber, can be used in place of the spring in the suspension system at a shorter life span than the spring.

Advantages

From the description above, a number of advantages of my cart with suspension become evident:
A. The suspension system, whether a spring or air shock, absorbs the shocks and forces of moving over bumpy or uneven ground providing for smoother, more stable travel.
B. By angling the suspension system so that it is perpendicular to the ground when moving cargo, the efficiency of the suspension system is maximized.
C. Expanding the wheel base to approximately one and a half times the width of the frame increases stability. This enables the cart to traverse rough terrain and slopes with a reduced tendency to tip over.
D. My cart does not have the weight and bulk of a hand truck but is capable of carrying loads over rougher and more diversified terrain than a hand truck.
E. My cart folds for easy storage and transport like a luggage cart, but the addition of the spring suspension system, wider wheel base, and pneumatic tires allows for use on all types of terrain, not just smooth, hard surfaces.

### Conclusion, Ramifications and Scope

Thus the reader will see that my cart provides for a highly versatile, lightweight, portable, and stable means of moving materials over many types of terrain. Furthermore, the cart has the additional advantages in that:
A. it allows the frame and cargo platform to be constructed of round tubular material, square tubular material or bar stock.
B. it allows the frame and cargo platform to be constructed of two, three, four, or any other number of members.
C. it allows the cart to be of various dimensions depending on the application.

Although the description above contains many specificities, these should not be construed as limiting the scope of the invention but as merely providing illustrations of some of the preferred embodiments of my invention. Many other variations are possible. For example, instead of a platform support, the outer ring can bend downwards to provide support.

Accordingly, the scope of the invention should be determined not by the embodiments illustrated, but by the approved claims and their legal equivalent.

1. A cart of the type foldable from a compact storage condition into an open condition for transporting cargo comprising;
(a) an elongated cart frame formed of a plurality of spaced apart opposite side members of a predetermined cross-sectional shape
(b) a handle of a predetermined cross-sectional shape extending from the top of said cart frame
(c) a cargo platform formed of a plurality of spaced apart opposite side members of a predetermined cross-sectional shape pivotally mounted to the lower part of said cart frame
(d) a first wheel means to move said cart mounted near the bottom end of said cart frame
(e) a versatile cart wherein an improvement comprises a first suspension means for shock absorption whereby said cart can operate over extreme terrain while maintaining stability and control.

2. The cart of claim one wherein an improvement comprises a first means of extending said first wheel means beyond said cart frame width increasing stability whereby said cart can operate across slopes without tipping over.

3. The cart of claim two wherein the extension of said first wheel means is approximately one and one half the width of said cart frame increasing stability whereby said cart can operate across slopes without tipping over.

4. The cart of claim one wherein said first suspension means is disposed between said wheel means and said cart frame.

5. The cart of claim one wherein said first suspension means utilizes a spring device for shock absorption.

6. The suspension of claim five wherein said spring device is a coil spring.

7. The cart of claim one wherein said first suspension means utilizes a first pneumatic means for shock absorption.

8. The cart of claim one wherein said first suspension means utilizes a first elastometric means for shock absorption.

9. The suspension of claim eight wherein said first elastometric means is rubber.

10. The cart of claim one wherein said first suspension means is disposed at an angle to enhance shock absorption.

11. The cart of claim 10 wherein the angle said first suspension means is disposed at is approximately forty five degrees to orient said suspension perpendicular to the ground when moving cargo to maximize suspension performance.

12. A method for stabilizing hand carts, comprising;
(a) a shock absorbing means which will absorb and dissipate shocks as said cart crosses rough or uneven terrain
(b) pneumatic tires which will absorb and dissipate shocks as said cart crosses rough or uneven terrain
(c) a means of supporting said tires outside the width of said cart providing enhanced stability as said cart crosses rough or uneven terrain
whereby said shock absorbing means is angled to a perpendicular orientation to the ground when the cart is in the cargo moving position.
